(19) United States
(12) Patent Application Publication
(10) Pub. No.: US 2009/0127246 A1
(43) Pub. Date: May 21, 2009

(54) Treated structural components for a cooking appliance

(75) Inventors: Donald Hendricks, Caryville, TN (US); Timothy Kolody, Powell, TN (US)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Home Appliances Corporation, Huntington Beach, CA (US)

(21) Appl. No.: 11/985,842

(22) Filed: Nov. 16, 2007

(51) Int. Cl. H05B 3/68

(52) U.S. Cl. 219/452.11

(57) ABSTRACT

A structural component for a cooking appliance includes a core structure formed from metal in a general configuration of the structural component for a cooking appliance; and an outer coating defining a ceramic layer formed by a plasma electrolytic oxidation treatment applied to the core structure of the structural component.

### BACKGROUND OF THE INVENTION

The present invention relates broadly to domestic cooking appliances such as freestanding ranges, drop-in ranges, drop-in cooktops and built-in ovens. More particularly, the present invention relates to structural components for such cooking appliances.

Cooking appliances are typically formed with several common components that, while differing in design and differences depending upon the particular common components that are shared among such appliances, facilitate the manufacturing of such appliances. Representative common components can include control knobs, doors, burners, grates, oven walls and the like. While such domestic appliances have increased in efficiency due to various manufacturing and design techniques over the years, safety, efficiency and weight remain important factors. Convenience as well as the weight of such components can provide direct benefits to the user. Further, the weight of such components can have an impact on the cost of the unit and the shipping costs.

Grates that support cookware on a gas range or stove are an example of a component of a cooking appliance whose weight and convenience of use can be significantly impacted by the configuration of the component. Grates are typically made from cast iron and are heavy, prone to corrosion and are not dishwasher safe. Furthermore, components such as brackets that connect an oven wall to its associated support member may undesirably transfer oven heat away from the oven and toward the casing or cabinet associated with the appliance. As another example of a component of a cooking appliance whose weight and convenience of use can be significantly impacted by the configuration of the component, insulation retainers commonly deployed in ovens transfer heat in a manner similar to the previously discussed oven wall support brackets and therefore any reduction of heat transfer therethrough would be an improvement.

It would therefore be advantageous if a process could be provided that results in improved material properties of components of the aforesaid domestic appliances to thereby provide improved performance, enhanced insulation properties, and reduced weight of the appliances.

### SUMMARY OF THE INVENTION

It is accordingly an object of the present invention to provide structural components for domestic appliances that include an outer ceramic surface.

It is another object of the present invention to provide structural components for cooking appliances which include a ceramic layer formed by a plasma electrolytic oxidation treatment.

To those ends, the present invention provides a structural component for a cooking appliance including a core structure formed from metal in a general configuration of the structural component for a cooking appliance. The present invention further includes an outer coating defining a ceramic layer formed by a plasma electrolytic oxidation treatment applied to the core structure of the structural component. Preferably, the present invention further includes an intermediate layer disposed between the outer coating and the core structure with the intermediate layer being formed as a mixture of metal and ceramic material during the plasma electrolytic oxidation treatment. It is also preferred that an external porous layer of ceramic material is disposed on the outer coating.

Preferably, core structure is formed as a cooking support grate. Further, the core structure may be formed as a cooking support grate from aluminum.

It is further preferred that the core structure is formed as a gas burner. Further, the core structure may be formed as a gas burner from aluminum.

Additionally, the core structure may be formed as an insulation retainer. Preferably, the core structure is formed as an insulation retainer from aluminum.

The present invention also provides, in one aspect thereof, a domestic cooking appliance, such as a freestanding range, a built-in range, a built-in oven or a drop-in cooktop. To that end, the present invention provides domestic cooking appliance including at least one structural component having a plasma electrolytic oxidation treatment applied thereto. Preferably, the structural component includes a core structure formed from metal in a general configuration of the structural component for a cooking appliance and an outer coating defining a ceramic layer formed by a plasma electrolytic oxidation treatment applied to the core structure of the structural component. It is further preferred that the intermediate layer is formed from a mixture of metal and ceramic material during the plasma electrolytic oxidation treatment and is disposed between the core structure and the ceramic layer. It is also preferred that an external porous layer of ceramic material is disposed on the outer coating.

Preferably, the core structure is formed as a cooking support grate. Further, the core structure may be formed as a cooking support grate from aluminum.

It is further preferred that the core structure is formed as a gas burner. Further, the core structure may be formed as a gas burner from aluminum.

Additionally, the core structure may be formed as an insulation retainer. Preferably, the core structure is formed as an insulation retainer from aluminum.

### BRIEF DESCRIPTION OF THE DRAWINGS

FIG. 1 is a front elevational view of a domestic cooking appliance in the form of a free standing range according to one preferred embodiment of the present invention;

FIG. 2 is a front perspective view of a cooking grate as illustrated in FIG. 1;

FIG. 3 is a cross section of a cooking grate formed according to a preferred embodiment of the present invention;

FIG. 4 is a partial prospective view of a cooktop featuring burners and grates according to a preferred embodiment of the present invention; and

FIG. 5 is a perspective view of an oven wall member being attached to a support member using brackets formed according to a preferred embodiment of the present invention.

### DESCRIPTION OF THE PREFERRED EMBODIMENTS

The present invention provides, in connection with a domestic cooking appliance, such as, for example, a freestanding range, a built-in range, a built-in oven or a drop-in cooktop, a method of treating at least one structural component of the domestic appliance. The present invention also provides a domestic cooking appliance having at least one structural component that has been treated in accordance with the method of the present invention. The method of the present invention relates to a plasma electrolytic oxidation treatment applied to structural components of domestic cooking appliances and specifically includes the application of a ceramic layer formed by a plasma electrolytic oxidation treatment to the structural component. The plasma electrolytic oxidation (PEO) surface coating treatment process in general will be initially discussed, followed by a discussion of an example of a plasma electrolytic oxidation (PEO) surface coating treatment process of an appliance component formed with aluminum. Then the drawings will be addressed in turn to discuss the present invention according to the preferred embodiments thereof. While the treatment of structural components of domestic cooking appliances with a plasma electrolytic oxidation (PEO) surface coating treatment process is discussed in detail herein, it will be understood by those skilled in the art that the treatment of structural components of domestic cooking appliances via other PEO-type processes as well as the treatment of structural components of appliances other than domestic cooking appliances are also within the spirit and scope of the present invention.

U.S. Pat. No. 6,896,785 to Shatrov et al., titled Process and Device For Forming Ceramic Coatings On Metals and Alloys, And Coatings Produced By This Process and U.S. Pat. No. 6,365,028 to Shatrov, titled Method For Producing Hard Protection Coatings On Aluminum Alloys are directed to a plasma electrolytic oxidation (PEO) surface coating treatment process that is commercially offered as the KERONITE® b plasma electrolytic oxidation (PEO) surface coating treatment process and coating by Keronite Limited, Advanced Surface Technology, PO Box 700, Granta Park, Great Abington, Cambridge CB1 6ZY, United Kingdom.

The plasma electrolytic oxidation (PEO) surface coating treatment commercially offered under the trademark KERONITE® is a plasma electrolytic oxidation (PEO) surface coating treatment commercially available by Keronite Limited and is a proprietary plasma electrolytic oxidation (PEO) surface coating treatment process by which a light alloy core emerges with a hardened ceramic surface with an intermediate layer of a ceramic and metal mixture therebetween. The plasma electrolytic oxidation (PEO) surface coating treatment process may be a plasma electrolytic oxidation (PEO) surface coating treatment plasma electrolytic oxidation (PEO) surface coating treatment commercially offered under the trademark KERONITE®, whereupon such a metal treatment results in metal transformation and hardening, ultimately producing a ceramic outer surface overlaying the surface of the treated metal, which can be aluminum or other light alloy metal. The plasma electrolytic oxidation (PEO) surface coating treatment is a treatment by which a light alloy core emerges with a hardened ceramic surface with an intermediate layer of a ceramic and metal mixture therebetween.

During the plasma electrolytic oxidation (PEO) surface coating treatment commercially offered under the trademark KERONITE®, a modulated electrical current is passed through a bath of proprietary electrolyte solution, converting the surface of light alloys into a hard, yet flexible ceramic. Parts are suspended from a bus bar and are submerged in the electrolyte inside a stainless steel electrode cage. During the process, a controlled plasma discharge is formed on the surface of the substrate, fusing the oxides of the substrate alloy into a harder phase.

The plasma electrolytic oxidation (PEO) surface coating treatment commercially offered under the trademark KERONITE® is used on base metals, commonly aluminum and magnesium to reduce the thermal conductivity of the base metals greatly, allowing them to be used as insulators or insulation. Further, the insulation properties of the resultant structure allow the plasma electrolytic oxidation (PEO) surface coating treatment commercially offered under the trademark KERONITE® to be used to treat aluminum to an extent that it may be substituted for heavier metals. The process involves electrolytic oxidation of the surface of components (immersed in an aqueous, phosphate-based solution) which produces a hard, dense and adherent layer of metal oxide ceramic, typically 5 to 200 μm thick.

The plasma electrolytic oxidation (PEO) surface coating treatment commercially offered under the trademark KERONITE® offers an environmentally friendly coating method for enhancing the wear, tribology and corrosion properties of a component surface, including access to restricted surfaces, while retaining initial component dimensions. As a ceramic, the surface has other useful characteristics: it acts as a thermal barrier and an electrical insulator, and yet unusually for a ceramic, the outer layer remains flexible and resistant to cracking or chipping and provides extremely good adhesion for scratch-resistant topcoats.

During the plasma electrolytic oxidation (PEO) surface coating treatment commercially offered under the trademark KERONITE®, a controlled high-frequency electrical current is passed through a bath of alkaline electrolyte solution. Parts are suspended from a bus bar and submerged in the electrolyte inside a stainless steel electrode cage. A controlled plasma discharge is formed on the surface, fusing the oxides of the substrate alloy into a harder phase. Acoustic vibration in the tank works with the complex electrical pulses to ensure that the ceramic layer is as smooth, hard and compact as possible.

Because of the nature of the process, the ceramic layer is self-regulating and a uniform thickness is automatically achieved, even along the edges and inner surfaces of the core may have complex shapes. This can often be an advantage over conventional dip processes, which can produce points of weakness around critical edges. As an immersion process, the plasma electrolytic oxidation (PEO) surface coating treatment commercially offered under the trademark KERONITE® has much greater throwing power than plasma sprayed ceramic surfaces or other line-of-sight processes.

Processing time is dependent upon the thickness of the ceramic coating required and the size of the parts being treated, but the ceramic layer will typically grow at around 1 micron per minute (1 μm/minute) on aluminum and up to 4 microns per minute (4 μm/minute) on magnesium surfaces. However, because there is no requirement for aggressive etching or other complex pre-treatments, productivity rates across the system as a whole are favorably to efficient manufacture.

The ceramic layer grows both above and below the surface of the component being treated and when examined under a scanning electron microscope (SEM), three distinct layers can be detected including a thin intermediate layer of less than one (1) micron (<1 μm) providing a strong, molecular bond between the metal substrate and the ceramic; a hard, dense, functional layer of fused ceramic that provides the protection against wear and corrosion; and an outer porous layer making up approximately 14% of the total coating thickness.

U.S. Pat. No. 6,896,785 to Shatrov et al., titled Process and Device For Forming Ceramic Coatings On Metals and Alloys, And Coatings Produced By This Process and U.S. Pat. No. 6,365,028 to Shatrov, titled Method For Producing Hard Protection Coatings On Aluminum Alloys disclose an example by which a specimen of aluminum alloy 2014 was oxidized for thirty-five minutes in phosphate-silicate electrolyte, pH 11, at temperature 40° C. Bipolar alternating electrical pulses of frequency 2500 Hz were supplied to the bath. The current density was 35 A/dm², and the final voltage (amplitude) was: anode 900V, cathode 400V. Acoustic vibrations were generated in the bath by an aerohydrodynamic generator. The pressure of the electrolyte at the input into the generator was 4.5 bars. A dense coating of a dark grey color, overall thickness 130±3 μm, including an external porous layer 14 μm thick, was obtained. The roughness of the oxide-coated surface was Ra 2.1 μm, its microhardness was 1900 HV, and the porosity of the hard functional layer (not the external porous layer) was 4%. Other such examples may be found in U.S. Pat. No. 6,896,785 to Shatrov.

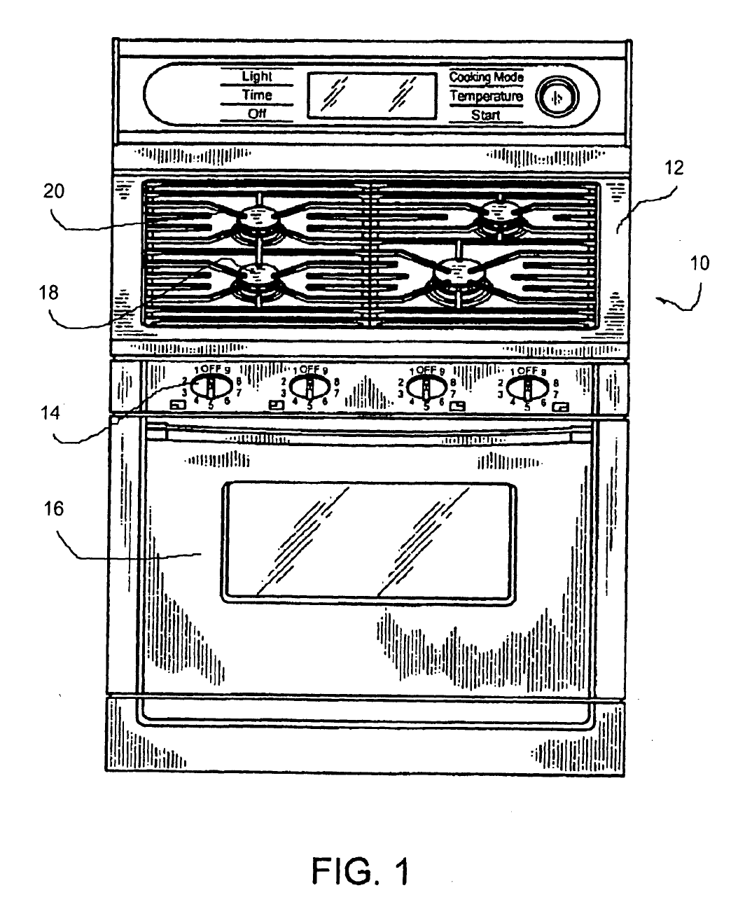

Turning now the drawings and, more particularly to FIG. 1, a domestic cooking appliance in the form of a free standing range as illustrated generally at 10 and includes a cooktop 12 supported by an oven-encasing body. Four burners 18 are positioned symmetrically about the cooktop and a series of grates 20 cover the areas surrounding the burners 18 to support cookware during the use thereof for food preparation. Controls 14 provide individual control for each burner. An oven door 16 covers an oven cavity which is formed from oven walls suspended from bracket members. Such bracket members will be discussed in greater detail hereinafter. The present invention is directed to improvements in certain structural components of the range 10 that result in enhanced insulation and reduced weight. While the present invention is discussed in terms of a free standing range as seen in FIG. 1, it should be understood that the principles applied herein are equally applicable to drop-in ranges, drop-in cooktops, and built-in ovens.

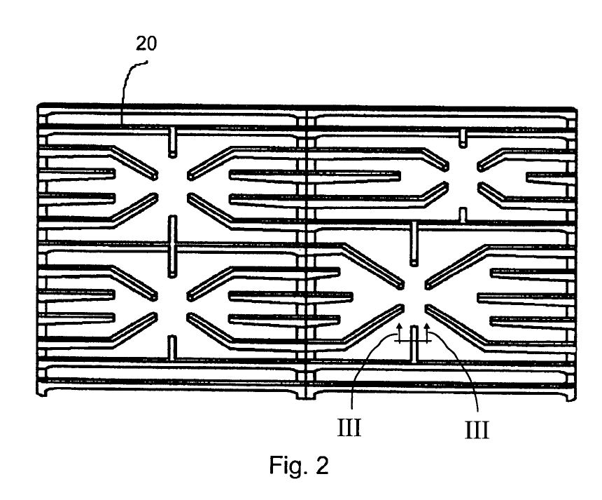

Referring now to FIG. 2, one of the cookware support grates 20 is illustrated as a symmetric structure and is formed as an arrangement of intersecting rails providing a substantially level surface. In this respect, the support grates 20 of the range 10 are geometrically similarly configured relative to one another in a like manner as known (prior art) support grates of commercially available cooking ranges can also be geometrically similarly configured relative to one another. The support grate 20 is typically formed from cast iron and, for example, given an approximately 30 inch width and approximately 18 inches of depth of some models of commercially available cooking ranges, the support grate such as the support grate 20 is, when formed from cast iron, a heavy structure in the context of a domestic kitchen. Cast iron also reacts adversely to moisture in the atmosphere and any painting can detract from the appearance and usefulness of the grate.

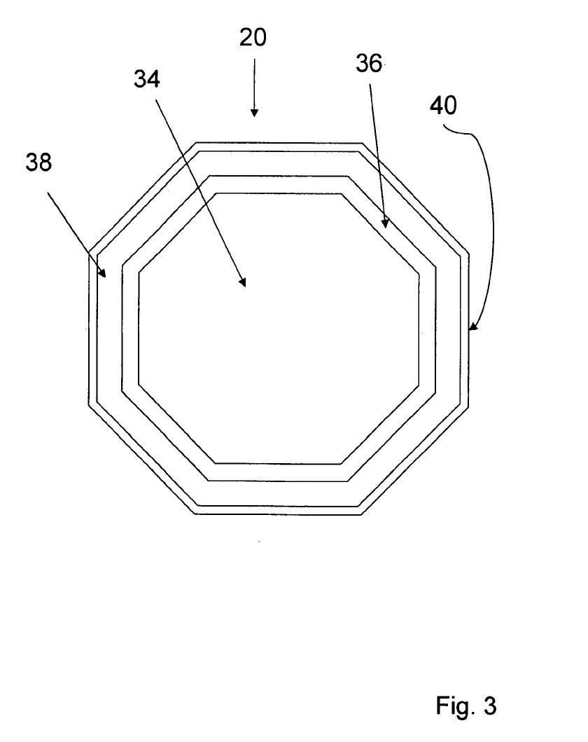

Referring now to FIG. 3, a representative cross section of a support grate 20 taken along lines III-III of FIG. 2 is illustrated. It will be noted that the grate cross section of the support grate 20 has an octagon shape as shown in FIG. 3. There is no required cross sectional configuration for such a grate and the octagonal grate cross section of the support grate 20 shown in FIG. 3 is merely provided as an illustration of one of a large variety of geometric configurations of a structural component of a domestic cooking appliance on which a coating can be applied via a plasma electrolytic oxidation (PEO) surface coating treatment process. In order to reduce the weight of the grate, an aluminum core 34 is provided and formed into the intersecting rail configuration as seen in FIG. 2. A plasma electrolytic oxidation (PEO) surface coating treatment process is applied to the core 34 resulting in an outer ceramic layer 38 and an intermediate layer 36 which consists of a mixture of aluminum and ceramic material. An external porous layer 40 is also formed which is less than 14% of the total coating thickness and has very low roughness, on the order of Ra 0.6 to 2.0 μm. The intermediate layer is approximately two millimeters thick and therefore provides little added thickness yet provides a strong bond between the ceramic layer 38 and the inner core 34. Such a coating applied to a grate that is the size of the cooktop-spanning grate illustrated in FIG. 1, provides a substantial reduction in weight, reducing the weight by approximately two-thirds. Further, the ceramic coating may be cleaned in a dishwasher. Therefore, the combination of reasonable weight and a ceramic coating allows the grate to be cleaned in a dishwasher.

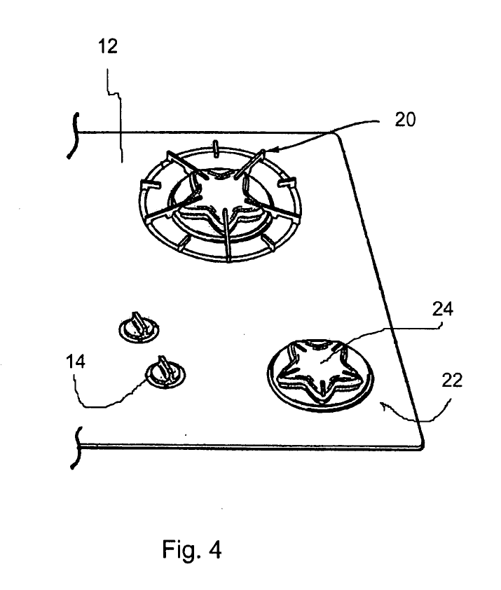

With reference to FIG. 4, an individual grate is illustrated at 20 on a cooktop 12. The cooktop 12 includes a plurality of star-configured or five-point burners 22. Such star burners 22 have a top portion that cooperates with a bottom portion to define nozzles and help direct gas from a gas supply outwardly through the nozzles where it is ultimately burned for cooking. The individual grate 20 may also be treated with a plasma electrolytic oxidation (PEO) surface coating treatment process and is shown here for illustrative purposes only. The burner cover 24 may be formed from aluminum and treated using the plasma electrolytic oxidation (PEO) surface coating treatment process. All the attendant advantages of the insulative properties of metal treated with the plasma electrolytic oxidation (PEO) surface coating treatment process as well as reduced weight are passed along to the burner 24.

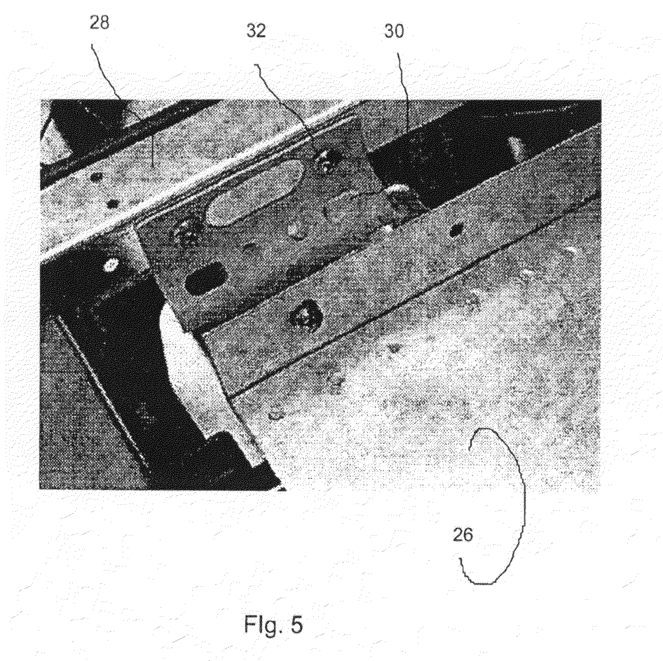

As seen in FIG. 5, an oven wall 26 is suspended from a support rail 28 and a bracket 30 provides an interface between the oven wall 26 and a support member 28. The bracket is held in place using screws 32 or other suitable fasteners. When conventional metals are used for the bracket, heat is readily transferred from the oven wall 26 through the bracket 30 and into the railing 28 and from there outwardly toward the atmosphere via the surface of the range. By providing a bracket treated with a plasma electrolytic oxidation (PEO) surface coating treatment process, enhanced insulated properties prevent heat from being readily transferred from the oven wall 26 to the support member 28. Therefore, the oven walls 26 will retain heat longer and thus provide more efficient operation of the range at hand.

An oven cavity wall at five hundred degrees Fahrenheit (500 degrees F.) when suspended on one of the brackets produces a temperature of around one hundred degrees Fahrenheit (129 degrees F.) on its support member. There is negligible heat transfer across the brackets. This property is enhanced when employing pyrolytic cleaning of the oven at approximately nine hundred degrees Fahrenheit (900 degrees F.) whereupon the temperature will be approximately 200 degrees along the rail. Similarly, insulation retainers that are also treated provide enhanced insulated properties and less heat is lost from the oven to the atmosphere.

By the above, the present invention provides structural components for domestic cooking appliances that have enhanced insulating properties and can also provide reduced weight components. Therefore, the ovens may be assembled, shipped and operated more efficiently and in a safer manner.

It will therefore be readily understood by those persons skilled in the art that the present invention is susceptible of a broad utility and application. While the present invention is described in all currently foreseeable embodiments, there may be other, unforeseeable embodiments and adaptations of the present invention, as well as variations, modifications and equivalent arrangements, that do not depart from the substance or scope of the present invention. The foregoing disclosure is not intended or to be construed to limit the present invention or otherwise to exclude such other embodiments, adaptations, variations, modifications and equivalent arrangements, the present invention being limited only by the claims appended hereto and the equivalents thereof.

We claim:

1. A structural component for a cooking appliance comprising:
a core structure formed from metal in a general configuration of the structural component for a cooking appliance; and
an outer coating defining a ceramic layer formed by a plasma electrolytic oxidation treatment applied to the core structure of the structural component.

2. The structural component for a cooking appliance according to claim 1 and further comprising an intermediate layer disposed between the outer coating and the core structure, the intermediate layer being formed as a mixture of metal and ceramic material during the plasma electrolytic oxidation treatment.

3. The structural component for a cooking appliance according to claim 1 and further comprising an external porous layer of ceramic material.

4. The structural component for a cooking appliance according to claim 1 wherein the core structure is formed as a cooking support grate.

5. The structural component for a cooking appliance according to claim 3 wherein the core structure is formed as a cooking support grate from aluminum.

6. The structural component for a cooking appliance according to claim 1 wherein the core structure is formed as a gas burner.

7. The structural component for a cooking appliance according to claim 5 wherein core structure is formed as a gas burner from aluminum.

8. The structural component for a cooking appliance according to claim 1 wherein the core structure is formed as an insulation retainer.

9. The structural component for a cooking appliance according to claim 5 wherein core structure is formed as an insulation retainer from aluminum.

10. A domestic cooking appliance comprising:
at least one structural component having a plasma electrolytic oxidation treatment applied thereto.

11. The domestic cooking appliance according to claim 10 wherein the structural component includes:
a core structure formed from metal in a general configuration of the structural component for a cooking appliance; and
an outer coating defining a ceramic layer formed by a plasma electrolytic oxidation treatment applied to the core structure of the structural component.

12. The domestic cooking appliance according to claim 11 wherein the intermediate layer is formed from a mixture of metal and ceramic material during the plasma electrolytic oxidation treatment and is disposed between the core structure and the ceramic layer.

13. The domestic cooking appliance according to claim 11 wherein the core structure is formed as a cooking support grate.

14. The domestic cooking appliance according to claim 11 wherein the core structure is formed as a cooking support grate from aluminum.

15. The domestic cooking appliance according to claim 11 wherein the core structure is formed as a gas burner.

16. The domestic cooking appliance according to claim 11 wherein core structure is formed as a gas burner from aluminum.

17. The domestic cooking appliance according to claim 11 wherein the core structure is formed as an insulation retainer.

18. The structural component for a cooking appliance according to claim 11 wherein core structure is formed as an insulation retainer from aluminum.
